(19) United States
(12) Patent Application Publication
(10) Pub. No.: US 2024/0157826 A1
(43) Pub. Date: May 16, 2024

(54) SYSTEMS AND METHODS FOR ELECTRICAL POWER DISTRIBUTION IN POWER MACHINES

(71) Applicant: Doosan Bobcat North America, Inc., West Fargo, ND (US)

(72) Inventors: Jaron Volk, Bismarck, ND (US); Preston Schatz, Bismarck, ND (US)

(21) Appl. No.: 18/506,743

(22) Filed: Nov. 10, 2023

Related U.S. Application Data
(60) Provisional application No. 63/424,190, filed on Nov. 10, 2022.

(51) Int. Cl. B60L 53/302

(52) U.S. Cl. CPC B60L 53/302

(57) ABSTRACT

Power systems are provided for a power machine, including power machines having a battery and a motor arranged to be powered by the battery. A first switch can be switched between open and closed states to control charging, pre-heating, or other operations for the battery and for the power system as a whole.

### CROSS-REFERENCE TO RELATED APPLICATIONS

This application claims priority to U.S. Provisional Application No. 63/424,190, filed Nov. 10, 2022, the entire contents of which is incorporated herein by reference.

### BACKGROUND

This disclosure is directed toward power machines. More particularly, this disclosure is related to power machines for mowing operations, including zero-turn mowers, that are configured to operate in whole or in part under electrical power. Power machines, for the purposes of this disclosure, include any type of machine that generates power to accomplish a particular task or a variety of tasks. One type of power machine is a work vehicle. Work vehicles are generally self-propelled vehicles that have a work device that can be operated to perform a work function. For example, mowers can include a mower deck with one or more rotatable blades that can be operated to cut grass, brush, or other material as the mower travels over terrain. Other work vehicles include loaders (including mini-loaders), excavators, utility vehicles, tractors (including compact tractors), and trenchers, to name a few examples.

Conventional power machines can include hydraulic or mechanical systems that are configured to transmit power from a power source (e.g., an internal combustion engine) to perform various work functions. For example, a power source can be configured to provide tractive power for moving a power machine along a support surface, as well as powering various work implements (e.g., to rotate a blade). Still, other power machines can include a power source (e.g., a battery) configured to provide electrical power to perform work functions, for example, by driving an electric motor or operating an electrical actuator.

The discussion above is merely provided for general background information and is not intended to be used as an aid in determining the scope of the claimed subject matter.

### SUMMARY

Embodiments of the present disclosure can allow power machines to be equipped with a power source (e.g., a battery) configured to provide electrical power to perform various work functions. A power distribution unit (PDU) can be configured to control a flow of electrical current to and from a battery (e.g., during charging, discharging, heating, or pre-charging operations). For example, a PDU according to the present disclosure can include a single contactor that is configured to control a flow of electrical current through the PDU to charge a battery via a charger, to operate a heating circuit for a battery, or to pre-charge and power a load with electrical current from the battery.

One configuration provides a power distribution system for a power machine that may include a battery, an inverter, and a motor arranged to be powered by the battery through the inverter. The power distribution system may include a power distribution unit (PDU). The PDU may include a battery power terminal that may be configured to electrically couple the PDU to a terminal of the battery of the power machine. The PDU may include a battery heater terminal that may be configured to electrically couple the PDU to a heating circuit for the battery. The PDU may include a charge terminal that may be configured to electrically couple the PDU to a power supply to charge the battery. The PDU may include a device power terminal that may be configured to electrically couple the PDU to the inverter of the power machine to power the motor. The PDU may include a pre-charge terminal that may be configured to electrically couple the PDU to the inverter separately from the device power terminal. The PDU may include an electrically conductive interconnection that may electrically couple the battery power terminal, the battery heater terminal, the charge terminal, the device power terminal, and the pre-charge terminal, where the device power terminal, the pre-charge terminal, and the battery heater terminal may be electrically connected to the electrically conductive interconnection between the battery power terminal and the charge terminal. The PDU may include a PDU switch switchable between an open state and a closed state to control a flow of electrical current through the electrically conductive interconnection, where, when the PDU switch is in the open state, the pre-charge terminal and the battery power terminal may be electrically isolated from the charge terminal, the battery heater terminal, and the device power terminal and, when the PDU switch is in the closed state, the pre-charge terminal and the battery power terminal may be electrically connected to the charge terminal, the battery heater terminal, and the device power terminal.

Another configuration provides a power distribution system for a power machine that may include a battery and a load. The power distribution system may include a power distribution unit (PDU). The PDU may include a battery power terminal that may electrically couple the PDU to a positive terminal of the battery of the power machine. The PDU may include a battery heater terminal that may electrically couple the PDU to a heating circuit for the battery. The PDU may include a charge terminal that may electrically couple the PDU to a power supply to charge the battery. The PDU may include an electrically conductive interconnection that may electrically couple the battery power terminal, the battery heater terminal, and the charge terminal, where the battery heater terminal may be electrically connected to the electrically conductive interconnection between the battery power terminal and the charge terminal. The PDU may include a PDU contactor switchable between an open state and a closed state to control a flow of electrical current through the electrically conductive interconnection, where, in the open state, the PDU contactor may electrically isolate the battery power terminal from the charge terminal and the battery heater terminal; and, in the closed state, the PDU contactor may electrically connect the battery power terminal to the charge terminal and the battery heater terminal.

Another configuration provides a method of operating a battery for a power machine. The method may include, when a battery temperature is below a threshold temperature, heating the battery by supplying an electrical current to a heating circuit using a power distribution system, the heating circuit may be in an active state to supply heat to the battery, the power distribution system may include an electrically conductive interconnection with a first contactor that is switchable between an open state and a closed state to control a flow of electrical current through the electrically conductive interconnection, the electrically conductive interconnection may be electrically coupled to a positive terminal of the battery, the heating circuit, and a charger for the battery so that the first contactor may be between the heating circuit and the positive terminal of the battery and between the charger and the positive terminal of the battery. The method may include, when the battery temperature is at or above the threshold temperature, charging the battery by supplying electrical current from the charger to the battery with the first contactor in a closed state and with the heating circuit in an inactive state, in which heat is not supplied to the battery by the heating circuit.

Another configuration provides a power distribution system for a power machine that may include a battery, an inverter, and a motor arranged to be powered by the battery through the inverter. The power distribution system may include a power distribution unit (PDU). The PDU may include a battery power terminal that may be configured to electrically couple the PDU to a positive terminal of the battery of the power machine. The PDU may include a battery heater terminal that may be configured to electrically couple the PDU to a heating circuit for the battery. The PDU may include a charge terminal that may be configured to electrically couple the PDU to a power supply to charge the battery. The PDU may include a motor power terminal that may be configured to electrically couple the PDU to the inverter of the power machine to power the motor. The PDU may include a pre-charge terminal that may be configured to electrically couple the PDU to the inverter separately from the motor power terminal. The PDU may include an electrically conductive interconnection that may electrically couple the battery power terminal, the battery heater terminal, the charge terminal, the motor power terminal, and the pre-charge terminal, where the motor power, pre-charge, and battery heater terminals may be electrically connected to the electrically conductive interconnection between the battery power terminal and the charge terminal. The PDU may include a PDU contactor switchable between an open state and a closed state to control a flow of electrical current through the electrically conductive interconnection, where, when the PDU contactor is in the open state, the pre-charge and battery power terminals may be electrically isolated from the charge, battery heater, and motor power terminals and, when the PDU contactor is in the closed state, the pre-charge and battery power terminals may be electrically connected to the charge, battery heater, and motor power terminals.

Another configuration provides a method of operating a battery for a power machine. The method may include, with a battery temperature below a threshold temperature, heating the battery by supplying an electrical current to a heating circuit using a power distribution system, the heating circuit being in an active state to supply heat to the battery, the power distribution system may include an electrically conductive interconnection with a first contactor that may be switchable between an open state and closed state to control a flow of electrical current through the electrically conductive interconnection, the electrically conductive interconnection may be electrically coupled to a positive terminal of the battery, the heating circuit, and a charger for the battery so that the first contactor is between the heating circuit and the positive terminal of the battery and between the charger and the positive terminal of the battery, where, while supplying the electrical current to heat the battery, the power distribution system may be in at least one of: a self-heating configuration, where the first contactor may be in a closed state so that electrical current may flow from the battery to the heating circuit via the first contactor, or an auxiliary-heating configuration, where the first contactor may be in an open state and electrical current may flow from the charger to the heating circuit via the electrically conductive interconnection. The method may include, with the battery temperature at or above the threshold temperature, charging the battery by supplying electrical current from the charger to the battery with the first contactor in a closed state and with the heating circuit in an inactive state, in which heat is not supplied to the battery by the heating circuit.

Another configuration provides a method of charging a battery for a power system of a power machine. The method may include, with an electronic controller, for a first temperature condition of a battery, operating the power system in a pre-heating configuration, which may include commanding a charger to supply an electrical current of zero amps at zero volts to a power distribution unit, the power distribution unit may include an electrically conductive interconnection with a first contactor that may be configured to control a flow of electrical current through the electrically conductive interconnection and a charge terminal that may be configured to electrically couple the charger to the electrically conductive interconnection, the power distribution unit may be electrically coupled to a positive terminal of the battery so that the first contactor is between the charge terminal and a positive terminal of the battery. The method may include operating the power system in a heating configuration, with the first contactor in an open state, which may include commanding the charger to supply an electrical current of more than zero amps at more than zero volts to a heating circuit via the power distribution unit with the heating circuit in an active state in which a heater of the heating circuit is electrically coupled to the electrically conductive interconnection to supply heat to the battery, the heating circuit may be electrically coupled to the electrically conductive interconnection so that the first contactor may be between the heating circuit and a positive terminal of the battery. The method may include, for a second temperature condition of the battery, operating the power system in a pre-charge configuration, which may include commanding the charger to supply an electrical current of zero amps at zero volts to the power distribution unit; and operating the power system in a charging configuration, with the first contactor in a closed state, which may include commanding the charger to supply an electrical current of more than zero amps at more than zero volts to battery via the power distribution unit.

Another configuration provides a power distribution unit (PDU) for a power machine that may include a battery, an inverter, and a motor arranged to be powered by the battery through the inverter. The PDU may include a battery power terminal that may be configured to electrically couple the PDU to a positive terminal of the battery of the power machine. The PDU may include a battery heater terminal that may be configured to electrically couple the PDU to a heating circuit for the battery. The PDU may include a charge terminal that may be configured to electrically couple the PDU to a power supply to charge the battery. The PDU may include a motor power terminal that may be configured to electrically couple the PDU to the inverter of the power machine to power the motor. The PDU may include a pre-charge terminal that may be configured to electrically couple the PDU to the inverter for charge equalization. The PDU may include an electrically conductive interconnection that may electrically couple the battery power terminal, the battery heater terminal, the charge terminal, the motor power terminal, and the pre-charge terminal, where the motor power, pre-charge, and battery heater terminals may be electrically connected to the electrically conductive interconnection between the battery power terminal and the charge terminal. The PDU may include a single contactor along the electrically conductive interconnection, the single contactor switchable between an open state and a closed state to control a flow of electrical current through the electrically conductive interconnection, to selectively heat, charge, and discharge the battery.

Another configuration provides a power distribution system for a power machine that may include a battery and a load. The power distribution system may include a power distribution unit (PDU). The PDU may include a battery power terminal that may electrically couple the PDU to a positive terminal of the battery of the power machine. The PDU may include a battery heater terminal the may electrically couple the PDU to a heating circuit for the battery. The PDU may include a charge terminal that may electrically couple the PDU to a power supply to charge the battery. The PDU may include an electrically conductive interconnection that may electrically couple the battery power terminal, the battery heater terminal, and the charge terminal, where the battery heater terminal may be electrically connected to the electrically conductive interconnection between the battery power terminal and the charge terminal. The PDU may include a PDU contactor switchable between an open state and a closed state to control a flow of electrical current through the electrically conductive interconnection, where, in the open state, the PDU contactor may electrically isolate the battery power terminal from the charge and battery heater power terminals; and, in the closed state, the PDU contactor may electrically connect the battery power terminal to the charge and battery heater terminals.

Another configuration provides a power system for a power machine. The power system may include a battery heating circuit that may be arranged to operate in an active state to heat a battery. The power system may include a power distribution system that may include a first contactor that may be switchable between an open state and a closed state to control a flow of electrical current between a positive terminal of the battery and the battery heating circuit and a charger for the battery, where the first contactor in the open state may electrically isolate the charger and the battery heating circuit from the positive terminal of the battery, and where the first contactor in the closed state may electrically connect the charger and the battery heating circuit to the positive terminal of the battery. The power system may include an electronic controller that may be configured to selectively operate the battery heating circuit to heat the battery, including: with a battery temperature below a threshold temperature, operating the battery heating circuit in the active state to heat the battery with the power distribution system in at least one of: a self-heating configuration, where the first contactor is in a closed state so that electrical current may flow from the battery to the battery heating circuit via the first contactor, or an auxiliary-heating configuration, where the first contactor is in an open state and electrical current may flow from the charger to the battery heating circuit; and with the battery temperature at or above the threshold temperature and with the first contactor in the closed state, maintaining the battery heating circuit in an inactive state.

Another configuration provides a power system for a power machine. The power system may include a battery heating circuit that may be arranged to operate in an active state to heat a battery. The power system may include a power distribution system that may include a first contactor that may be switchable between an open state and a closed state to control a flow of electrical current relative to a positive terminal of the battery, the battery heating circuit, and a charger for the battery, where the first contactor in the open state may electrically isolate the charger and the battery heating circuit from the positive terminal of the battery, and where the first contactor in the closed state may electrically connect the charger and the battery heating circuit to the positive terminal of the battery. The power system may include an electronic controller that may be configured to operate the battery heating circuit, which may include: detecting that a power supply is electrically connected to the power distribution system by the charger; and, in response to detecting that the power supply is electrically connected to the power distribution system by the charger, operating the battery heating circuit in an active state to heat the battery with current from the charger.

This Summary and the Abstract are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter.

### DRAWINGS

The following drawings are provided to help illustrate various features of examples of the disclosure and are not intended to limit the scope of the disclosure or exclude alternative implementations.

FIG. 1 is a block diagram illustrating functional systems of a representative power machine on which embodiments of the present disclosure can be advantageously practiced.

FIG. 2 is a perspective view showing generally a front of a power machine in the form of a zero-turn mower on which embodiments disclosed in this specification can be advantageously practiced.

FIG. 3 is a block diagram illustrating components of a hydraulic power system of a loader such as the mower of FIG. 2.

FIG. 4 is a schematic view of a power distribution system for a power machine according to aspects of the disclosure, with the power distribution system in a standby or “off” configuration.

FIG. 5 is a flowchart of a method of operating a power distribution system for a power machine to control the flow of an electrical current through the power distribution system to perform one or more power machine functions, according to aspects of the disclosure.

FIG. 6 is a schematic view of the power distribution system of FIG. 2 in a charge-equalization configuration.

FIG. 7 is a schematic view of the power distribution system of FIG. 2 in an operating configuration.

FIG. 8 is a flowchart of a method of operating power distribution system for a power machine to charge a battery of the power distribution system.

FIG. 9 is a schematic view of the power distribution system of FIG. 2 in a charge initialization configuration.

FIG. 10 is a schematic view of the power distribution system of FIG. 2 in a charging configuration.

FIG. 11 is a schematic view of the power distribution system of FIG. 2 in a self-heating configuration.

FIG. 12 is a schematic view of the power distribution system of FIG. 2 in an auxiliary-heating configuration.

### DETAILED DESCRIPTION OF THE PRESENT DISCLOSURE

The concepts disclosed in this discussion are described and illustrated by referring to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

As used herein, and in the context of electrical systems and an associated flow of electrical current, discussion of a first component “between” a second component and a third component indicates that the electrical current flows through the first component to move from the second component to the third component, or vice versa to flow from the third component to the second component. As also used herein in the context of electrical systems, “spatially between” indicates that a described component is located in a spatial area that is between reference components. Thus, in the context of electrical systems, a component that is between other components (for flow of electrical current) may or may not be spatially between those components.

As also used herein, in the context of electrical systems, discussion of a first component (or components) being “electrically isolated” from a second component (or components) indicates that the first component (or components) and the second component (or components) are separated such that electrical current cannot flow between the first component (or components) and the second component (or components). Thus, in the context of electrical systems, when a component is electrically isolated from another component, electrical current flow between the component and the other component is restricted or otherwise prevented. As also used herein, in the context of electrical systems, discussion of a first component (or components) being “electrically coupled” or “electrically connected” with a second component (or components) indicates that electrical current can flow between the first component (or components) and the second component (or components). Thus, in the context of electrical systems, when a component is electrically connected or coupled with another component, electrical current can flow between the component and the other component.

As used herein, a “contactor” generally refers to an electronic device configured to switch an electric circuit on and off (e.g., between an open state and a closed state). In some examples, a contactor may be utilized to control power (e.g., to connect or disconnect a power source). A contactor may also generally be referred to as a “switch,” an “electronic switch,” a “relay,” an “electrically-controlled switch,” etc. While the technology disclosed herein is described with reference to a “contactor,” another type of switch or switching device may be implemented, including, e.g., a relay, an electronic switch, etc.

Also, unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

The present disclosure provides improved systems and methods for distributing electrical power (e.g., electrical current) in power machines. In some examples in particular, improved systems and methods are provided for power machines having a power source (e.g., a battery) configured to supply electrical power, as opposed to hydraulic of mechanical power, to operate certain power machine components (e.g., drive or workgroup motors) or otherwise implement certain power machine functionality. Generally, an improved arrangement of one or more switchable contactors for a power distribution system (e.g., a single main contactor) can be configured to be switchable between an open state and a closed state to selectively distribute power for charging a battery, for pre-heating a battery, for powering a load, or for pre-charging a load (e.g., capacitive pre-charging of an inverter).

To control the distribution of electrical power, some power machines according to the present disclosure can include a power distribution unit (PDU) that is configured to control a flow of electrical current in the power machine. A PDU can include various terminals to electrically couple the PDU with other components of the power machine, as can generally be configured according to any variety of known designs for electrically coupling (i.e., operatively electrically coupling) an electrical source or load to a conductor (e.g., to a bus bar of the PDU). For example, a PDU can include one or more of: a battery power terminal configured to electrically couple the PDU to a positive terminal of a power source of the power machine (e.g., a battery with an operational voltage between 24 and 60 volts), a charge terminal configured to electrically couple the PDU to a power supply (e.g., a charger) to charge the battery, a device power (or load) terminal configured to electrically couple the PDU to a powered device circuit (e.g., to an inverter that is electrically coupled to drive a motor, or another load for power machine operations), and a pre-charge terminal configured to operatively electrically couple the PDU to the powered device circuit (e.g., to the inverter) for charge equalization.

Within the PDU, various terminals can be electrically coupled to one another via an electrically conduction interconnection such as a bus bar (e.g., a positive bus bar), a printed circuit board, or any other suitable connection structure. Correspondingly, discussion herein regarding a bus bar should be understood to also be applicable to otherwise similar systems that employ PCBs, various conductive wiring arrangements, etc. In some examples, a single bus bar can connect at least charge terminal and a battery power terminal, or can connect the charge terminal, the battery power terminal, and one or more of a battery heater terminal, a first load terminal (e.g., to operatively power the load), or a second load terminal (e.g., to pre-charge capacitors of the load before executing various operations with the load). Depending on the particular configuration of the power machine (e.g., whether a battery has an operational voltage of greater than 60 volts), a PDU can be a separate component that can be installed separately from a battery (e.g., to be secured to different portions of a frame of a power machine), or a PDU can be integral with a battery (e.g., part of a larger assembly of a plurality battery cells, the PDU, and a battery management system).

In some examples, a PDU contactor that is switchable between an open state and a closed state can be provided on the bus bar to control the flow of electrical current through the bus bar. In some examples, the PDU contactor may be an electronic device, including, e.g., a relay, a switch, etc. In particular, the PDU contactor can in some cases be arranged as a single operational contactor of the PDU, positioned to control flow through the bus bar (e.g., positioned on or along the bus bar) so that control of a single contact in the PDU (i.e., the PDU contactor) can switch the PDU between battery charging, battery heating (e.g., pre-heating before powered operation of the power machine), battery discharging (e.g., to execute various power machine operations with a powered load), load pre-charging (e.g., to pre-charge capacitors of an inventor), or other configurations. For example, a PDU contactor can be positioned on a bus bar so that, in the open state, one or more of the pre-charge terminal or the battery power terminal are electrically isolated from one or more of the charge terminal, the device power terminal, or the battery heater terminal. Conversely, in the closed state, the PDU contactor can electrically couple the pre-charge terminal or the battery power terminal to the charge terminal, the battery heater terminal, or the device power terminal.

By arranging the PDU contactor and terminals in this way, system and control complexity and manufacturing costs can be reduced, and overall operational efficiency can be correspondingly improved. However, depending on needs of a particular configuration, a PDU can sometimes further include a second contactor for other control purposes. For example, a PDU can include an additional contactor on a second bus bar (e.g., a negative bus bar) that is electrically coupled a negative terminal of the battery. In such a case, for example, a PDU can include multiple contactors, but only a single contactor for a bus bar that is configured to connect to a positive terminal of a battery.

In some examples, one or more additional contactors can be provided (e.g., outside of the PDU) for further functionality. For example, a pre-charge contactor can be arranged between a bus bar of a PDU and an inverter (or other relevant load) along a pre-charge connection path, so as to electrically connect the inverter and a battery along the pre-charge connection path when the pre-charge contactor is in a closed state. The pre-charge connection path can extend electrically in parallel with a separate power connection path between the PDU and the inverter (or other load), and a main contactor of the PDU can be arranged to electrically isolate the pre-charge and power connection paths when in an open state. In such a system, before the inverter (or other load) is operationally powered by the battery, capacitors of the inverter (or other relevant load component) can be pre-charged by opening the main contactor and then temporarily closing the pre-charge contactor so that the battery is electrically connected to the charger only via the inverter (or other load). After sufficient pre-charging (e.g., once the capacitors are charged to a threshold voltage difference), the pre-charge contactor can be re-opened and the main contactor can be closed so that the battery is electrically connected to power the inverter via the power connection path (and the main contactor).

In some cases, it can be advantageous to heat a battery to be at or above a threshold temperature prior to suppling electrical power from a power supply to charge the battery. Correspondingly, and as also noted above, a PDU can include a battery heater terminal that is configured to electrically couple the PDU to a heating circuit (e.g., as included in a battery). More specifically, a battery heater terminal can be coupled to a bus bar so that a PDU contactor (e.g., as discussed above) electrically isolates the battery heater terminal from the battery power terminal in the open state. The heating circuit can be selectively operable (e.g., switchable) between an active state, in which received electrical current is used to supply heat to the battery to increase the temperature of the battery (also referred to herein as a battery temperature), and an inactive state, in which heat is not supplied to the battery by the heating circuit to increase the battery temperature. Accordingly, the heating circuit can include a variety of heating devices, for example, a resistive heater (e.g., a positive temperature coefficient (PTC) heater) that is operable via a switching device (e.g., a MOSFET).

In some examples, accordingly, a single PDU contactor can be switched between an open state and a closed state to control a flow of electrical current through the PDU, to selectively heat, charge, and discharge a battery. For example, when a battery temperature is below a threshold temperature (e.g., approximately 0 degrees Celsius), a PDU can be operated to selectively heat a battery using a heating circuit in a self-heating configuration or in an auxiliary heating configuration. In particular, in the self-heating configuration, power from the battery may be used to operate the heating circuit, and in the auxiliary heating configuration, power from a charger may be used to operate the heating circuit. In the self-heating configuration, the PDU contactor can be in the closed state to allow electrical current to flow from the battery to the heating circuit via the PDU contactor and electrical current is generally not supplied to the heating circuit by a charger that is electrically coupled to the PDU at a charge terminal. In the auxiliary-heating configuration, the PDU contactor can be in the open state and the charger can supply electrical current through the PDU to the heating circuit, via a heating circuit terminal. The heating circuit can be in the active state in both the self-heating configuration and the auxiliary-heating configuration, and the electrical current can be supplied in accordance with a demand from the heating circuit (e.g., a demand of a resistive heater).

In some cases, a heating circuit can be selectively operated using charger power rather than battery power. For example, a controller of a power machine can be configured to detect whether a power supply is connected to a PDU via a charger and, when such a connection is present, to cause a heating circuit to operate in an active state to heat a battery using power from the charger. In some cases, such control can be implemented regardless of a charge state of the battery.

In some examples, a PDU can be configured to charge the battery when a battery temperature is at or above a threshold temperature. In particular, with a charger electrically coupled to the PDU at a charge terminal, and a PDU contactor in a closed state, the charger can supply to the PDU a desired electrical current (e.g., a non-zero current) at a desired voltage (e.g., a non-zero voltage), which can flow to the battery via the bus bar and PDU contactor. The particular power (e.g., electrical current and voltage) supplied by the charger can be selected in accordance with a state of charge (SOC) of the battery. In the charging configuration, the heating circuit may be in an inactive state so as not to supply heat to the battery.

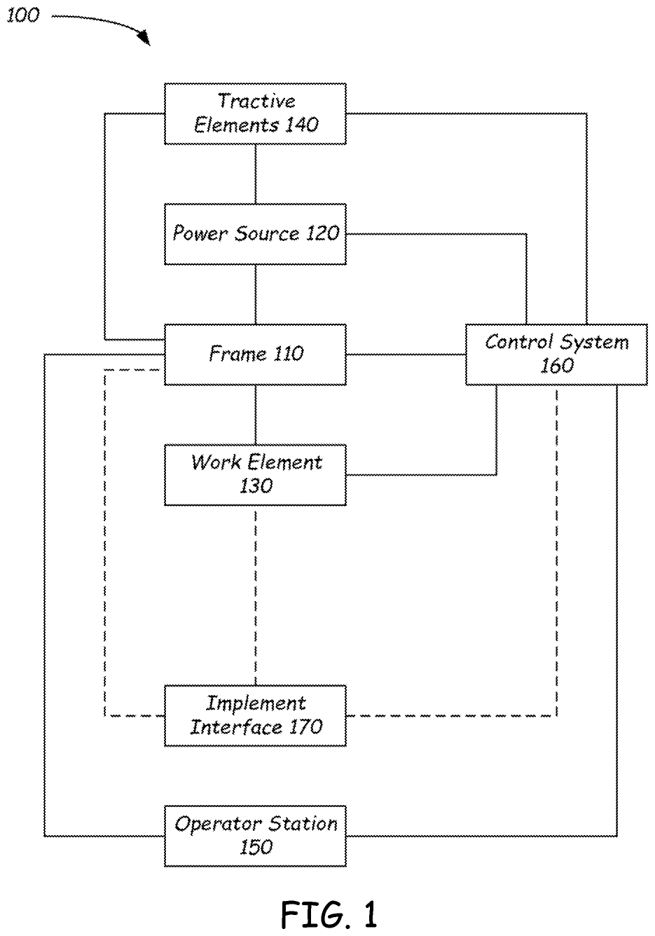

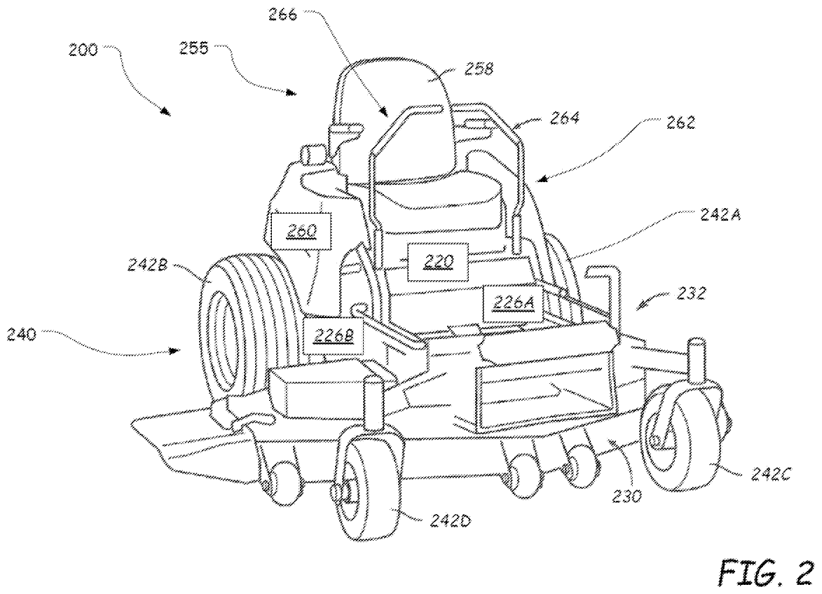

These concepts can be practiced on various power machines, as will be described below. A representative power machine on which the embodiments can be practiced is illustrated in diagram form in FIG. 1 and one example of such a power machine is illustrated in FIG. 2 and described below before any embodiments are disclosed. For the sake of brevity, only one power machine is discussed. However, as mentioned above, the embodiments below can be practiced on any of a number of power machines, including power machines of different types from the representative power machine shown in FIG. 2. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power. In some examples, a power machine can be a self-propelled mower, including a mower with a work element configured as a mower deck with one or more rotating blades, and additional work elements configured as separately controllable right- and left-side drive elements to allow skid-steer operation.

FIG. 1 is a block diagram that illustrates the basic systems of a power machine 100, which can be any of a number of different types of power machines and upon which the embodiments discussed below can be advantageously incorporated. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator. For example, the control system 160 can be an integrated or distributed architecture of one or more processor devices and one or more memories that are collectively configured to receive operator input or other input signals (e.g., sensor data) and to output commands accordingly for power machine operations

Certain work vehicles have work elements that can perform a dedicated task. For example, some work vehicles have a mower deck that can be attached to a main frame of the work vehicles in various ways (e.g., as an implement attached to a lift arm). Cutting elements of the mower deck can then be controlled (e.g., to control speed of one or more rotating blades) or the mower deck can be otherwise manipulated (e.g., moved relative to the main frame of the power machine) to perform mowing or other tasks.

Some work vehicles may be able to accept other implements by disassembling a current implement/work element combination and reassembling with another implement in place of the original. Generally, work vehicles are intended to be used with a wide variety of implements and can have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130, or may include more complex mechanisms or structures. In some embodiments, the implement interface can be a pinned connection that secures a mower deck to a movable support structure so that the support structure can be moved relative to a main frame of the power machine to adjust a height (or other orientation) of the mower deck.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which can provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160 (e.g., a system of electronic, hydraulic, electro-hydraulic, or other control devices), which in turn selectively provides power to the elements that are capable of using the power to perform a work function. Power sources for power machines typically include an engine such as an internal combustion engine and a power conversion system such as a mechanical transmission or a hydraulic system that can convert the output from an engine into a form of power that is usable by a work element. Other types of power sources can be incorporated into power machines, including electrical sources or a combination of power sources, known generally as hybrid power sources.

FIG. 1 shows a single work element designated as a work element 130, but various power machines can have any number of work elements. Work elements are typically attached to the frame of the power machine and movable with respect to the frame when performing a work task. In some embodiments, as also discussed above, work elements can include mower decks or other similar equipment. In some embodiments, work elements can include lift arm assemblies or other similar systems. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether they have operator compartments, operator positions or neither, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both the power machine and any implement to which is it coupled) that is capable of controlling at least some of the operator-controlled functions on the power machine.

FIG. 2 illustrates a mower 200, which is one particular example of a power machine of the type illustrated in FIG. 1 where the embodiments discussed below can be advantageously employed. Mower 200 is one particular example of the power machine 100 illustrated broadly in FIG. 1 and discussed above. To that end, features of mower 200 described below include reference numbers that are generally similar to those used in FIG. 1. For example, mower 200 is described as having a frame 210, just as power machine 100 has a frame 110.

Mower 200 is shown as a zero-turn riding lawn mower, but it could also be a differently configured riding lawn mower, or a walk-behind or pull-type lawn mower. Correspondingly, the description herein of mower 200 with references to FIG. 2 provides an illustration of the environment in which the embodiments discussed below can be practiced, and this description should not be considered limiting especially as to the description of features of the mower 200 that are not essential to the disclosed embodiments. Such features may or may not be included in power machines other than mower 200 upon which the embodiments disclosed below may be advantageously practiced. Unless specifically noted otherwise, embodiments disclosed below can be practiced on a variety of power machines, with the mower 200 being only one of those power machines. For example, some or all of the concepts discussed below can be practiced on many other types of work vehicles such as various other mowers, as well as loaders, excavators, trenchers, and dozers, to name but a few examples.

Mower 200 includes frame 210 that supports a power system 220 that can generate or otherwise provide power for operating various functions on the power machine. Frame 210 also supports a work element in the form of mower deck 230 that is powered by the power system 220 and that can perform various work tasks (e.g., cutting at different blade speeds or deck heights). As mower 200 is a work vehicle, the frame 210 also supports a tractive system 240, which is also powered by power system 220 and can propel the power machine over a support surface. In particular, in the illustrated example, the tractive system 240 includes powered wheels 242A, 242B, as well as un-powered casters 242C, 242D, as further discussed below.

A deck support assembly 232 supports the deck 230 relative to the frame 210 and can be configured for selective adjustment to provide different cutting heights, angles, etc. for the deck 230, as well as for selective removal of the deck 230 or installation of additional or alternative work elements (e.g., other mower decks, ducts, and other material handling devices for cut plant material, etc.). The deck 230 can include one or more rotatable blades (not shown), which can be controlled (e.g., collectively or individually) to cut grass or other material, and which can be powered by hydraulic, electronic, or mechanical connections to the power system 220.

As a riding lawn mower, the mower 200 includes an operator station 255 supported on the frame 210, from which an operator can manipulate various control devices to cause the mower 200 to perform various work functions. In the illustrated example, in particular, the operator station 250 includes an operator seat 258, as well as the various operation input devices 262 in communication with a control system 260 (e.g., a hydraulic control system, or an electronic control system including an electronic hub controller and other distributed controllers that are electronically in communication with the hub controller). The input devices 262 generally allow an operator to control tractive and workgroup operations, so that the mower 200 can be directed to move over terrain and selectively cut grass or other plants along the terrain (or otherwise executed desired work operations).

In some case, the input devices 262 can allow for skid-steer tractive control of the mower 200. For example, the input devices 262 can include left- and right-side control levers 264, 266 that can be independently moved by an operator to direct, respectively, rotation of left- and right-side drive motors 226A, 226B for independent commanded rotation of left- and right-side tractive elements (e.g., the drive wheels 242A, 242B, as shown). In some cases, the levers 264, 266 can directly control delivery of hydraulic or other power. In some cases, the levers 264, 266 can indirectly control power delivery, including by adjusting a pilot flow for a powered hydraulic system of the mower 200 or by providing electronic signals that direct control of hydraulic, electronic, or other power delivery systems by way of one or more intervening hydraulic or electronic controllers included in the control system 260. Further, other configurations are possible for operator input devices, including configurations with different types of control levers that an operator can manipulate to control various machine functions. In some configurations, the operator input devices 262 can include a joystick (e.g., only a single joystick for tractive operations), a steering wheel, buttons, switches, levers, sliders, pedals, and the like, which can be stand-alone devices such as hand operated levers or foot pedals, or can incorporated into hand grips or display panels, and can sometimes include programmable input devices.

As generally noted above, actuation of operator input devices can generate signals in the form of electrical signals, hydraulic signals, or mechanical signals. Signals generated in response to operator input devices are provided to various components on the power machine for controlling various functions on the power machine. Among the functions that are controlled via operator input devices on the mower 200 are operational functions of the tractive system 240, the mower deck 230, other implements (not shown) including various other attachments (not shown).

In some cases, the control system 260 can be configured to operate without input from operator input devices 262 for one or more operations. For example, the control system 260 can be configured for automatic control of certain operations of the mower 200 or can include wireless communication capabilities so as to receive control commands or other relevant data from remotely located (i.e., not mechanically tethered) and other systems.

Mowers can sometimes include other human-machine interfaces, including display devices that are provided in the operator station 255 to give indications of information relatable to the operation of the power machines in a form that can be sensed by an operator, such as, for example, audible and/or visual indications. Audible indications can be made in the form of buzzers, bells, and the like or via verbal communication. Visual indications can be made in the form of graphs, lights, icons, gauges, alphanumeric characters, and the like. Displays can be dedicated to providing dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided. Other power machines, such as walk behind mowers for example, may not have a cab nor an operator compartment, nor a seat. The operator position on such mowers is generally defined relative to a position where an operator is best suited to manipulate operator input devices.

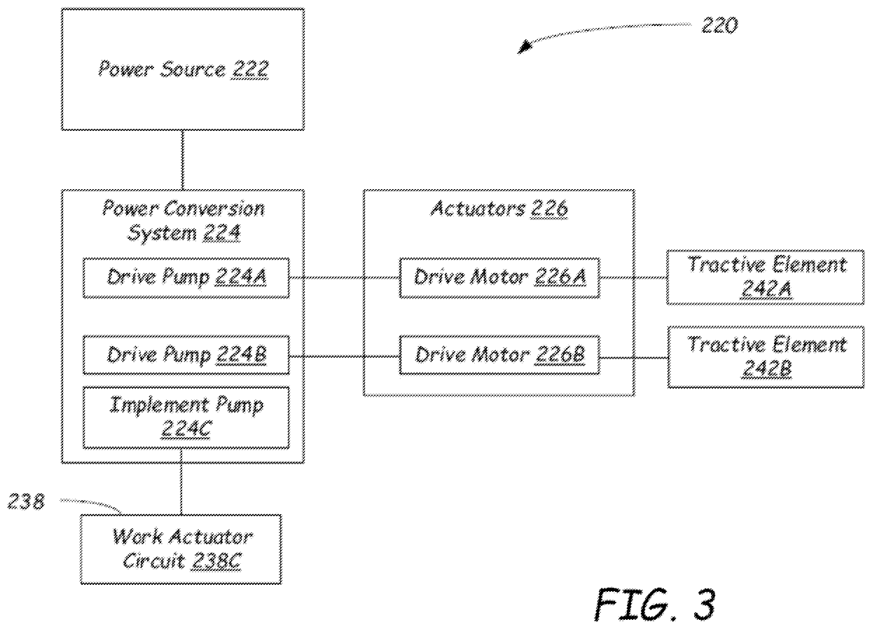

FIG. 3 illustrates an example of power system 220 in more detail for a hydraulically powered system. Broadly speaking, power system 220 includes one or more power sources 222 that can generate or store power for operating various machine functions. On the mower 200, the power system 220 may include an internal combustion engine. Other power machines can include electric generators, rechargeable or replaceable batteries, various other power sources or any combination of power sources that can provide power for given power machine components. The power system 220 may also include a power conversion system 224, which is operably coupled to the power source 222. The power conversion system 224 is, in turn, coupled to one or more actuators 226, which can perform a function on the power machine. Power conversion systems in various power machines can include various components, including mechanical transmissions, hydraulic systems, and the like. In a hydraulically powered example, the power conversion system 224 of the mower 200 can include hydrostatic drive pumps 224A, 224B, which provide a power signal to drive motors 226A, 226B, respectively. The drive motors 226A, 226B in turn are each operably coupled to a respective tractive element 242A, 242B (e.g., the wheels 242A, 242B as shown in FIG. 2). The hydrostatic drive pumps 224A, 224B can be mechanically, hydraulically, or electrically coupled to operator input devices (or otherwise in communication with the control system 260) to receive actuation signals for controlling the drive pump. The power conversion system 224 may also include an implement pump 224C, which can be driven by the power source 222 to provide pressurized hydraulic fluid to a work actuator circuit 238 for operation of a work actuator 239 (e.g., one or more motors for rotation of the blades of the deck 230). The work actuator circuit 238 can include valves and other devices to selectively provide pressurized hydraulic fluid to the various work actuators represented by block 239 in FIG. 3. In addition, the work actuator circuit 238 can be configured to provide pressurized hydraulic fluid to work actuators on an attached implement.

As also noted above, in some cases, actuators of a power machine can be electrically powered. Correspondingly, in some cases, the power conversion system 224 may include electronic or other devices configured for transmission of electrical current to, and general control of, one or more electric motors included in the actuators 226 (e.g., left- and right-side drive motors) and one or more electric motors of non-tractive work elements (e.g., electronic motors included on the deck 230 to power rotation of cutting blades).

The description of power machine 100 and mower 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and, more particularly, on a mower, such as zero-turn mower 200, unless otherwise noted or recited, the concepts discussed below are not intended to be limited in their application to the environments specifically described above.

As briefly mentioned above, in some embodiments, a power machine can be configured as an electrically powered power machine (e.g., a hybrid or fully-electric power machine), in which one or more functions of the power machine can be performed using electrical power. For example, in some cases, a power machine (e.g., the mower 200) can be configured as an electrically powered mower that includes a power source configured as a battery (e.g., a lithium-ion battery). To distribute power to and from a battery (e.g., for charging and discharging), a power machine can include a power distribution system that is electrically coupled to the battery and configured to control a flow of electrical current through the power machine.

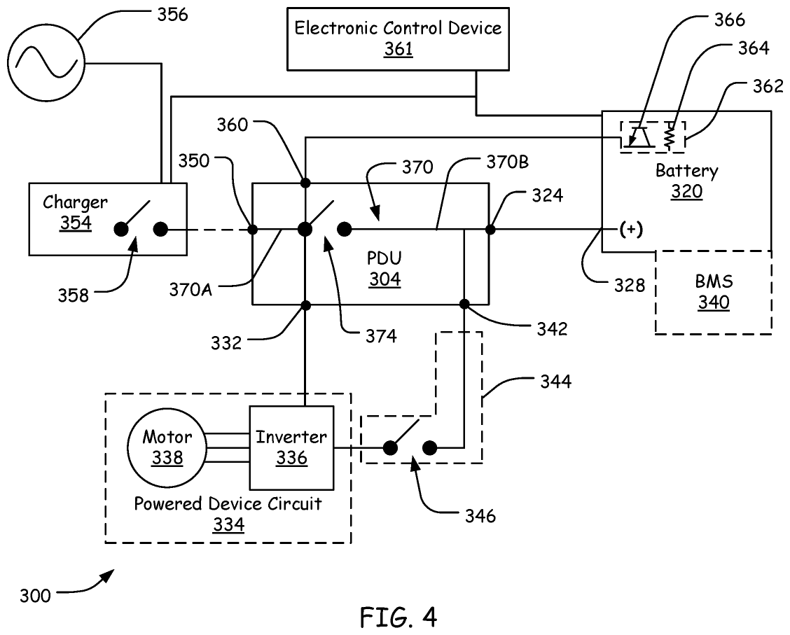

FIG. 4 illustrates an example of a power distribution system 300 for a power machine (e.g., the mower 200) that is configured to control a flow of electrical current in the power machine to perform one or more power machine functions. The power distribution system 300 can generally include a power distribution unit (PDU) 304 that is configured to electrically couple one or more electrical circuits to a battery 320 or another power source that is configured to supply electrical power. Accordingly, in some configurations, the PDU 304 may provide for or otherwise include an electrically conductive interconnection between one or more components (or terminals thereof), as described in greater detail herein. In some examples, the electrically conductive interconnection (as provided by the PDU 304) may facilitate the electrical coupling (or connection) of the one or more electrical circuits to the battery 320.

The battery 320 can be of any type of battery chemistry and can have a variety of operational voltages and capacities in accordance with the needs for a particular application. As one particular example, the battery 320 can be a lithium-ion battery with an operational voltage between approximately 24 volts and approximately 60 volts (inclusive), and, more specifically, between approximately 48 volts and 60 volts, or approximately 60 volts. In other embodiments, the battery 320 can have any other voltage required by the specific application, which can be greater than 60 volts (e.g., between approximately 300 volts and approximately 600 volts), or less than 24 volts. Also, depending on the particular application (e.g., to improve packaging or comply with any particular manufacturing or other standards), the PDU 304 can be physically separated from the battery 320 (e.g., to be positioned at different physical locations relative to the frame 210 of the mower 200), or may be integrated into (e.g., to be disposed in or otherwise secured to) the battery 320 or a battery housing (not shown).

To electrically couple electrical circuits to the battery 320, the PDU 304 can include one or more terminals. More specifically, the terminals can electrically couple the PDU 304 to the electrical circuits so that the PDU 304 is between the battery 320 and the one or more electrical circuits. Accordingly, the PDU 304 can allow electrical current (e.g., direct electrical current) to flow between the battery 320 and any connected electrical circuits. As illustrated in FIG. 4, the PDU 304 includes a battery power terminal 324 that is configured to electrically couple the PDU 304 to a battery terminal 328 (e.g., a positive terminal) of the battery 320. Additionally, the PDU 304 includes a first load terminal configured, in the example shown, as a device power terminal 332 (e.g., a motor power terminal) to electrically couple the PDU 304 to a powered device circuit 334 (e.g., a circuit configured to carry out a function of a power machine).

The powered device circuit 334 includes an inverter 336 and a motor 338 as shown, although a variety of other loads for power machine operations can be used in other embodiments. In particular, in the example shown, the powered device circuit 334 is arranged so that the inverter 336 is between the PDU 304 and the motor 338. In other embodiments, other electronic components can be included in the powered device circuit 334, for example, an electric actuator, a work implement, a tractive element, etc. Additionally, in some embodiments, additional device power terminals may be provided to electrically couple other powered device circuits to the PDU 304.

In some embodiments, the powered device circuit 334 can be switchable between an active state, in which electrical current flows through the powered device circuit 334, and an inactive state, in which electrical current does not flow through the powered device circuit 334. An active and inactive state of the powered device circuit 334 may correspond with an active and inactive state of a component of the powered device circuit 334, for example, the inverter 336. The powered device circuit 334 can be controlled by a battery management system (BMS) 340 or other electronic controller of the power machine (e.g., an electronic control device 361 as in FIG. 4 (connection to device circuit 334 not shown)) to switch the powered device circuit 334 between the active state and the inactive state.

In some cases, and as will be described in greater detail below, the PDU 304 can include a second load terminal. For example, as shown in FIG. 4, a pre-charge terminal 342 can be configured to electrically couple the PDU 304 to the powered device circuit 334 (e.g., to the inverter 336), for capacitive charge equalization prior to charging, key-on, or any other condition in which electrical current can flow through the PDU 304 to power the powered device circuit 334 in the active state (e.g., to operate the motor 338). More specifically, a pre-charge circuit 344 is electrically coupled between the pre-charge terminal 342 and the inverter 336, separated from the device power terminal 332 by a main contactor of the PDU 304 (as further discussed herein). The pre-charge circuit 344 can include a pre-charge relay 346 between the pre-charge terminal 342 and the inverter 336. The pre-charge relay 346 can be switchable between an open state, in which the PDU 304 is electrically coupled to the powered device circuit 334 at the pre-charge terminal 342, and a closed state, in which the PDU 304 is electrically decoupled from the powered device circuit 334 at the pre-charge terminal 342. In particular, in the closed state, the pre-charge relay 346 can thus provide pre-charging for the powered device circuit 334 by electrically connecting the battery terminal 328 (e.g., the positive terminal) of the battery to a charger 354 (e.g., a power supply) via the powered device circuit 334.

Switching of the pre-charge relay 346 (or other relay) between open and closed states can be controlled by, for example, a BMS (e.g., the BMS 340) or other electronic control device of a power machine (e.g., the electronic control device 361) with appropriate relative timing or based on other appropriate criteria. For example, the pre-charge relay 346 can be switched to the closed state prior to an electrical current flowing through the PDU 304 (e.g., prior to closing a PDU contactor 374) so that sensitive electrical components in the powered device circuit 334 can be appropriately pre-charged (e.g., to charge capacitors in the inverter 336 to be at the voltage of the battery 320). That is, prior to supplying electrical current (e.g., current from the battery 320) at the device power terminal 332 to operate the powered device circuit 334 (e.g., to power the motor 338) or to charge the battery 320, the pre-charge relay 346 can be switched to the closed state, thereby electrically coupling the inverter 336 to the battery 320. By electrically coupling the inverter 336 to the battery 320 with the pre-charge relay 346, electrical current can flow from the battery 320 to the inverter 336 to slowly charge any capacitors therein, or to equalize the voltage of any electrical components within the inverter 336 to the voltage of the battery 320.

Generally, therefore, the pre-charge relay 346 can be switched temporarily to a closed state before a different contactor (e.g., the PDU contactor 374) is closed for charging of the battery 320 or for powered operation of the powered device circuit 334. As a result, in some configurations, a further relay may not be need between a charger (as further discussed herein) and the powered device circuit 334. Similarly, transition of the circuitry of the power distribution system 300 between a charging state, a pre-charging state, a heating state, or an operational state can be controlled solely through operation of the main contactor and the pre-charge relay 346 (aside from any relays internal to the charger). In other words, the power distribution system 300 can be transitioned between a charging state, a pre-charging state, a heating state, or an operational state by controlling only a single relay along a bus bar 370 within the PDU 304, a single relay along the pre-charge circuit 344, or no relay along a parallel connection between the PDU 304 and the powered device circuit 334 (i.e., a connection that extends from the bus bar 370 to the powered device circuit via the device power terminal 332). As noted herein, in some examples, the PDU 304 provides for or otherwise facilitate an electrically conductive interconnection between one or more components (or terminals thereof). In some examples, the bus bar 370 or the single relay along the bus bar 370 may provide for (or be) the electrically conductive interconnection.

In some cases, a resistor or other electrically resistive component (not shown) can be provided to control (e.g., to limit) the flow of electrical current to a powered circuit (e.g., the powered device circuit 334). The resistor can be included in either of a pre-charge circuit or a powered device circuit (e.g., the powered device circuit 334).

Continuing with respect to FIG. 4, the PDU 304 can also include a charge terminal 350 that can be configured to electrically couple the PDU 304 to an external power supply (e.g., grid power) that can supply electrical current to charge the battery 320 (or heat the battery 320, as also discussed herein). As illustrated in FIG. 4, an external power supply configured as a charger 354 is provided to supply electrical current to charge the battery 320. In some cases, the charger 354 can be configured to convert alternating electrical current from a power grid 356 or other external power source (e.g., a generator) to direct electrical current that is supplied to the PDU 304 at the charge terminal 350, and that can thereby flow through the PDU 304 to charge the battery 320. As described in greater detail herein, the charger 354 can be configured as an automatic charger that can communicate with the power distribution system 300 (e.g., via the BMS 340 or the electronic control device 361) of the power machine.

Generally, the power distribution system 300 can command the charger 354 to supply an electrical current at a desired amperage. Correspondingly, in some embodiments, the charger 354 can include a charge contactor 358 that is switchable between an open state and a closed state to control the flow of electrical current from the charger 354 to the PDU 304 (e.g., to the power distribution system 300). The charge contactor 358 can be switched between the open state and the closed state in accordance with a command from the power distribution system 300. For example, the charge contactor 358 can be in the closed state upon receiving a request to supply an electrical current of zero amps.

In some cases, particularly in cold environments, it can be advantageous to charge a battery when the battery is at or above a minimum threshold temperature (e.g., approximately 0 degrees Celsius or another temperature). Accordingly, in some cases, the PDU 304 can further include a battery heater terminal 360 that is configured to electrically couple the PDU 304 to a battery heating circuit 362. The battery heating circuit 362 can include a resistive heating element that can be controlled by a switching component to move between an active state, in which heat energy is supplied to the battery 320 to raise the battery temperature, and an inactive state, in which heat is not supplied to the battery 320. In the illustrated embodiment, the battery heating circuit 362 includes a positive temperature coefficient (PTC) heating element 364 that is switched between the active state and the inactive state by a MOSFET 366. The MOSFET 366 can be controlled by the BMS 340 or other electronic controller (not shown) of the power machine (e.g., the mower 200) to switch the battery heating circuit 362 between the active state and the inactive state. In other embodiments, other types of heating elements or switching elements can also be used.

To provide for the flow electrical current within the PDU 304, for example, to flow between any terminals of the PDU 304 (via, e.g., the electrically conductive interconnection), the terminals can be electrically coupled to a first bus bar (e.g., a positive bus bar) disposed in the PDU 304. Correspondingly, a first PDU contactor (e.g., a positive contactor) can be provided along the first bus bar to control the flow of electrical current therethrough. More specifically, in some examples, a single first contactor can be positioned along the first bus bar, relative to the various terminals, so that the first contactor can selectively control heating, charging, or discharging of a battery of a power machine. In some cases, a first contactor along a first bus bar can be the sole contactor along the first bus bar, so that the first contactor can be solely controlled to place the PDU 304 in a particular state for power distribution, as generally also corresponds with various states of one or more external switches (e.g., the pre-charge relay 346) and the charge contactor 358.

Still referring to FIG. 4, the PDU 304 includes the (positive) bus bar 370 with the PDU contactor 374 as a single (main) PDU contactor 374. Each of the terminals of the PDU 304 can be electrically coupled to the bus bar 370 so that the bus bar 370 can provide electrical connections (e.g., the electrically conductive interconnection) between the terminals depending on the state of the PDU contactor 374. In the illustrated example, the PDU contactor 374 is positioned along the bus bar 370 relative to the terminals, to selectively transition the power distribution system 300 between heating, charging, or discharging of the battery 320.

More specifically, to selectively allow for heating, charging, or discharging of the battery 320, the PDU contactor 374 is switchable between an open state and a closed state to control a flow of electrical current through the bus bar 370, and thus the flow of electrical current between the various terminals (via, e.g., the electrically conductive interconnection). In particular, the PDU contactor 374 may be positioned along the bus bar 370 so that, in the open state, the battery power terminal 324 and the pre-charge terminal 342 are electrically isolated from each of the charge terminal 350, the device power terminal 332, and the battery heater terminal 360. Correspondingly, in the closed state, the PDU contactor 374 electrically couples the battery power terminal 324 and the pre-charge terminal 342 to each of the charge terminal 350, the device power terminal 332, and the battery heater terminal 360. Also, in both the closed state and the open state, the battery power terminal 324 is electrically coupled to the pre-charge terminal 342 by the bus bar 370, and each of the charge terminal 350, the device power terminal 332, and the battery heater terminal 360 are electrically coupled with each other by the bus bar 370. The PDU contactor 374 can be controlled by the BMS 340 or other electronic controller of the power machine (e.g., the electronic control device 361) to switch the PDU contactor 374 between the open state and the closed state.

In some embodiments, the PDU 34 can also include a second bus bar (e.g., a negative bus bar) that corresponds with a negative terminal of the battery 320 (not shown for clarity of illustration in the figures). Depending on the particular application and operational voltage of the battery 320, a second PDU contactor (e.g., a negative contactor, also not shown) can be provided on the second bus bar to control the flow of electrical current through the second bus bar Like the first PDU contactor (e.g., the PDU contactor 374), the second PDU contactor can be switchable between an open state and a closed state to control the flow of electrical current through the second bus bar.

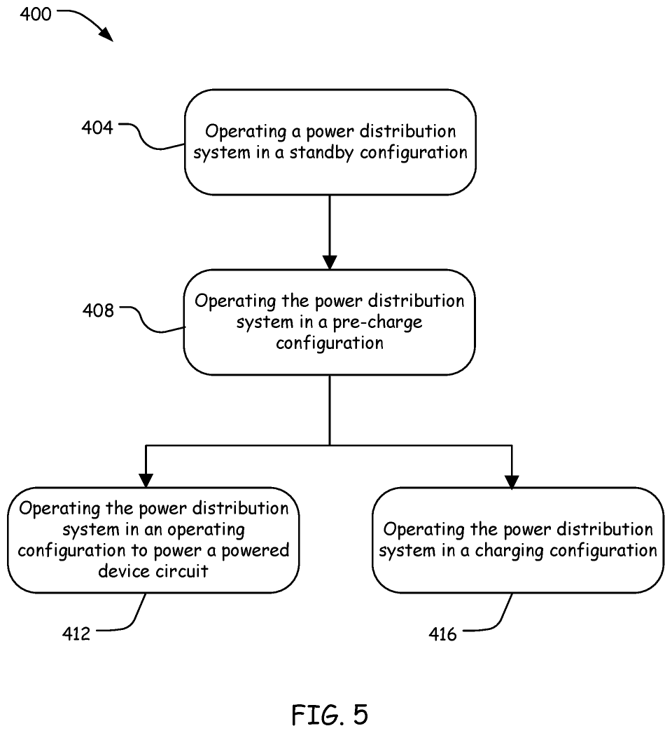

The power distribution system 300 can be selectively switched between various operational states, for example, to selectively heat, charge, or discharge a battery, to selectively pre-charge a load, or for other operations. In this regard, FIG. 5 illustrates a method 400 of operating a power distribution system (e.g., a method of operating a battery) to switch between various operational states. While the method 400 may be discussed in relation to the power distribution system 300, application of the method 400 is not limited to this specific embodiment and may be applied to other types of power machines and configurations of power distribution systems.

At block 404, the method 400 can include operating the power distribution system 300 in a standby or “off” configuration, in which electrical current does not flow through the power distribution system 300. That is, electrical current does not flow through any portion of the bus bar 370 of the PDU 34 in the standby configuration. For example, FIG. 4 illustrates the power distribution system 300 in the standby configuration where no electrical current flows through any portion of the bus bar 370.

In particular, in the illustrated example standby configuration of FIG. 4, the PDU contactor 374 is in the open state to electrically isolate the battery power terminal 324 and the pre-charge terminal 342 from each of the charge terminal 350, the device power terminal 332, and the battery heater terminal 360. The pre-charge terminal 342 is also in the open configuration, to prevent electrical current from flowing between the battery 320 (e.g., via the battery power terminal 324) and the powered device circuit 334 (e.g., the inverter 336) via the pre-charge circuit 344. Similarly, the charge contactor 358 can be in the open state or the charger 354 can be disconnected from the charge terminal 350, and the battery heating circuit 362 can be in the inactive state, so that no electrical current can flow though the battery heating circuit 362. Likewise, the powered device circuit 334 can also be in the inactive state so that no electrical current can flow though the powered device circuit 334 (e.g., to operate the motor 338).

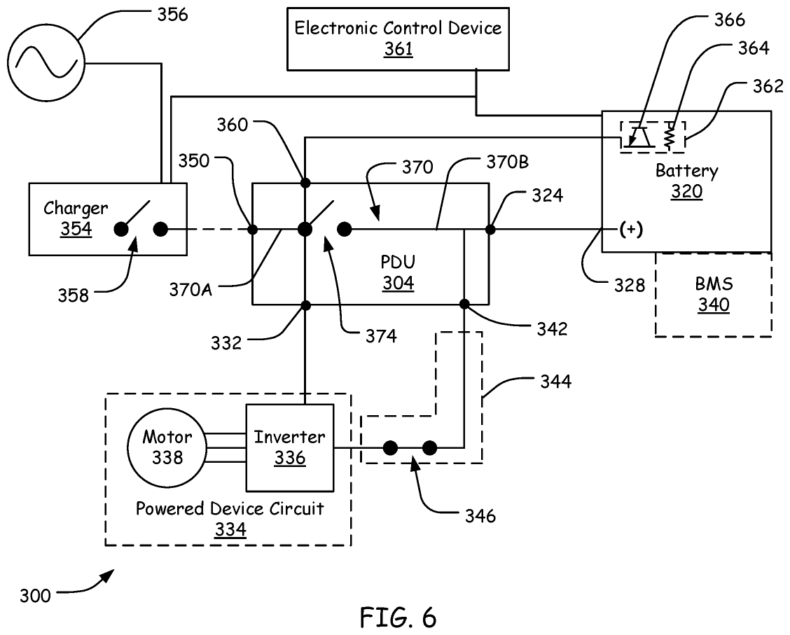

At block 408, the method 400 can include operating the power distribution system 300 in a charge-equalization configuration by switching the pre-charge relay 346 from an open state to a closed state to pre-charge components of the powered device circuit 334 and thereby equalize a voltage potential across a main PDU relay (e.g., the PDU contactor 374). For example, the pre-charge relay 346 can be switched from the open state (see FIG. 4) to the closed state as illustrated FIG. 6 prior closing the PDU contactor 374 to allow electrical current to flow through the bus bar 370.

In some cases, in the pre-charging state, the charger 354 does not supply operative electrical current to the PDU 304 (e.g., with the charger 354 disconnected from the charge terminal 350 or the charge contactor 358 in the open state) and each of the powered device circuit 334 and the battery heating circuit 362 are in the inactive state. Accordingly, the charger side (represented by reference numeral 370A) of the bus bar 370 (i.e., the portion of the bus bar that is electrically coupled to the device power terminal 332, charge terminal 350, and battery heater terminal 360 to one side of the PDU contactor 374) is at zero volts. However, because the battery 320 is electrically coupled to the battery side of the bus bar 370 (i.e., the portion of the bus bar 370 that is electrically coupled to the battery 320, represented by reference numeral 370B), the voltage on the battery side of the bus bar 370 (represented by reference numeral 370B) will be at the same voltage as the battery terminal 328. Thus, by switching the pre-charge relay 346 to the closed state, the charger side of the bus bar 370 (represented by reference numeral 370A) can be electrically coupled with the battery side of the bus bar 370 (represented by reference numeral 370B) via the pre-charge circuit 344 and the powered device circuit 334. Electrical current can thus flow through the pre-charge circuit 344 and the powered device circuit 334 to equalize voltage between the charger side of the bus bar 370 (represented by reference numeral 370A) and the battery voltage (e.g., to equalize charge voltage across capacitors of the inverter 336). Accordingly, the voltage at each side of the PDU contactor 374 can be equalized, to minimize a voltage potential across the PDU contactor 374, which can help to reduce arcing when the PDU contactor 374 is switched to a closed state.

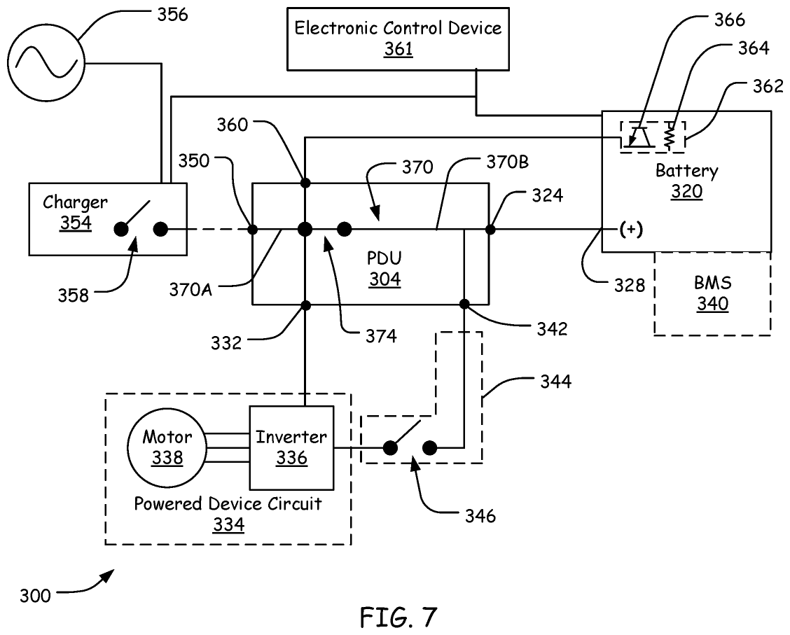

When a SOC of the battery 32 is above a minimum SOC (e.g., above 0%), the method 400 can include, at block 412, operating the power distribution system 300 in an operating configuration to power the powered device circuit 334 with the battery 320, as can thereby reduce the SOC of the battery 320. For example, FIG. 7 illustrates the power distribution system 300 in an operating configuration to power the powered device circuit 334. The operating configuration is generally similar to the charge-equalization configuration (see FIG. 6), but with the PDU contactor 374 switched to the closed state to electrically couple the charger side of the bus bar 370 (represented by reference numeral 370A) with the battery side of the bus bar 370 (represented by reference numeral 370B), and with the pre-charge relay 346 switched to the open state (e.g., switched after the PDU contactor 374 is closed). With the PDU contactor 374 in the closed state, electrical current can flow from the battery 320 and through the bus bar 370 to the powered device circuit 334, discharging the battery 320. Correspondingly, the powered device circuit 334 can be in the active state so that the electrical current flowing from the battery 320 can power (e.g., operate) the motor 338. In some cases, the flow of electrical current from the battery 320 to the powered device circuit 334 can be based on a demand from the powered device circuit 334 (e.g., a demand of the motor 338), and may be controlled by the BMS 340 or another electronic controller of the power machine (e.g., the electronic control device 361), including as also based on an input from an operator.

Generally, operations at block 412 can include opening the pre-charge relay 346 before closing the PDU contactor 374. Thus, for example, once pre-charge operations have been sufficiently completed, the pre-charge relay 346 can be opened to electrically isolate the battery 320 from the powered device circuit 334 along the pre-charge circuit 344. Once the pre-charge relay 346 has been opened, the PDU contactor 374 can then be closed so that operational power can be provided to the powered device circuit 334 via the PDU contactor 374 and the device power terminal 332.

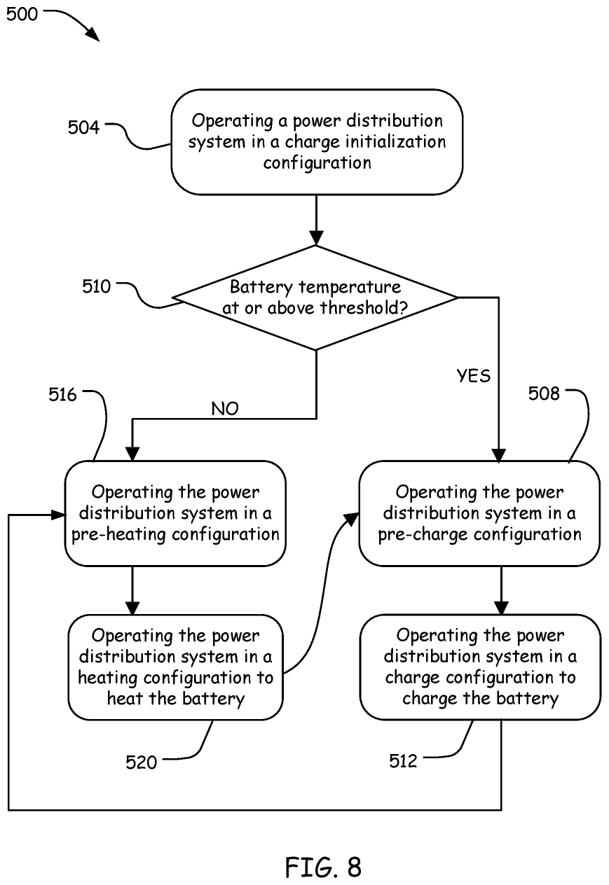

Referring again to FIG. 5, when a SOC of the battery 320 is below a maximum SOC (e.g., below 100%), the method 400 can include, at block 416, operating the power distribution system 300 in a charging configuration to increase the SOC of the battery 320. For example, with additional reference to FIG. 8, operations at block 416 can include operating the power distribution system 300 in accordance with a method 500 for charging a battery. Similar to the method 400, while the method 500 may be discussed in relation to the power distribution system 300, application of the method 500 is not limited to this specific embodiment and may be applied to other types of power machines and configurations of power distribution systems.

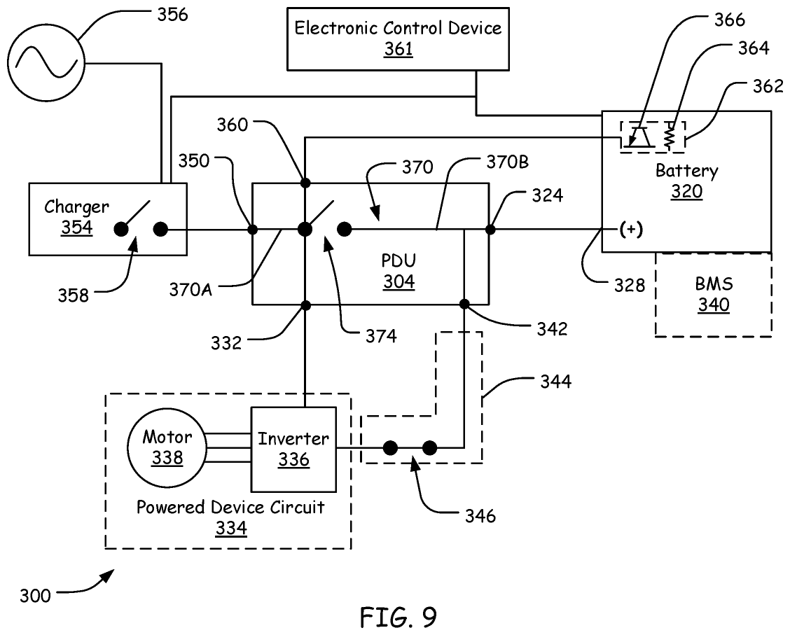

At block 504, the method 500 can include operating the power distribution system 300 in a charge initialization configuration. In some embodiments, the power distribution system 300 can automatically enter the charge initialization configuration upon connecting the charger 354 to the power distribution system 300 (e.g., upon a user electrically coupling the charger 354 to the charge terminal 350 of the PDU 304). In other embodiments, the power distribution system 300 may enter the charge initialization configuration upon receiving a command from an operator, or may operate in a charger initialization configuration as a default. For example, with additional reference to FIG. 9, the power distribution system 300 is in a charge initialization configuration with the charger 354 electrically coupled to the PDU 304 at the charge terminal 350. In the charge initialization configuration, upon connecting the charger 354 to the PDU 304, the power distribution system 300 can establish communication with the charger 354 and can command the charger 354 (e.g., via the electronic control device 361) to supply an electrical current of zero amps. Correspondingly, the charge contactor 358 can be switched to the open state to prevent electrical current from flowing to the power distribution system 300. Correspondingly, the powered device circuit 334 and the battery heating circuit 362 can be in the inactive state.

In some implementations, subsequent operations of the method 500 can be executed based on a battery temperature of the battery 320. As mentioned above, it can be advantageous to charge a battery only when a battery temperature of the battery 320 is at or above a minimum threshold temperature of the battery 320. The minimum threshold temperature can vary depending on the specific application or battery chemistry being used, but can be, for example, approximately 0 degrees Celsius. Thus, for example, particular implementations for charging and discharging operations can proceed in some cases based on a detected battery temperature (e.g., using temperature sensors (not shown) of various known configurations in electronic communication with the electronic control device 361)

In particular, at block 508, the power distribution system 300 can be operated in a pre-charge configuration when a battery temperature satisfies a first temperature condition by being, for example, at or above a minimum temperature threshold (e.g., “Yes” at block 510). In some implementations, a pre-charge configuration can be similar to a charge initialization configuration. For example, FIG. 9 can also illustrate the power distribution system 300 in a pre-charge configuration. In particular, the pre-charge configuration can be substantially similar to the charge-equalization configuration, as discussed above with respect to FIG. 6, with the pre-charge relay 346 in the closed state to equalize voltage across the PDU contactor 374. Additionally, the power distribution system 300 can be electrically coupled to the charger 354 and can command the charger 354 to supply an electrical current of zero amps, which may cause the charge contactor 358 to be in the open state.

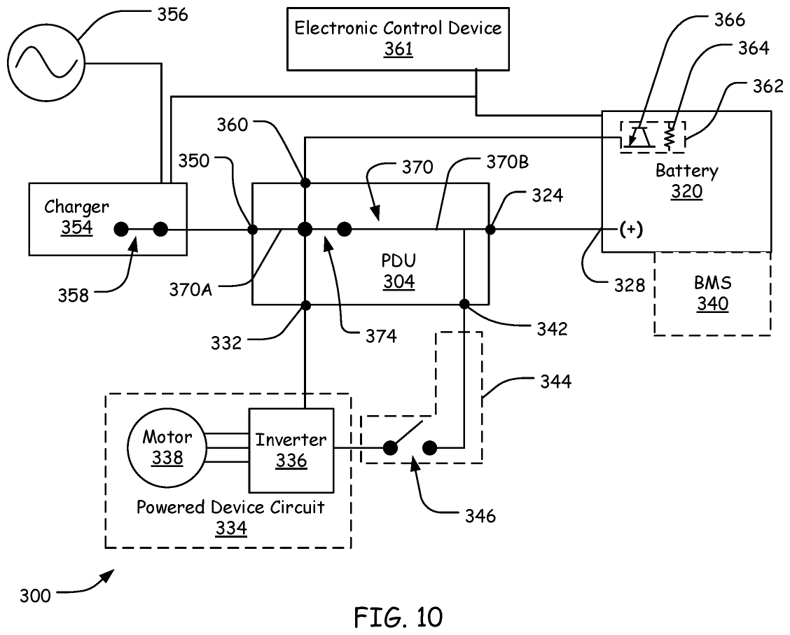

Following charge initialization at block 504 and operation at a pre-charge configuration at block 508, the battery 320 can be charged by the charger 354 with the power distribution system 300 in a charging configuration at block 512. For example, with reference to FIG. 10, the power distribution system 300 is in a charging configuration in which electrical current is supplied to the battery 320 by the charger 354, via the PDU 304. In the charging configuration, the PDU contactor 374 is in the closed state, the pre-charge relay 346 is in the open state, and the powered device circuit 334 and the battery heating circuit 362 remain in the inactive state so that electrical current from the charger 354 only flows to the battery 320. Correspondingly, the power distribution system 300 (e.g., via the BMS 340) can command the charger 354 to supply a desired electrical current (e.g., an electrical current of non-zero amps) to the PDU 304 to charge the battery 320 via the PDU contactor 374. As appropriate, a command from the power distribution system 300 can also cause the charge contactor 358 to be switched to the closed state, to electrically couple the power distribution system 300 to the power grid 356 via the charger 354.

Referring again to FIG. 8, when the temperature of the battery satisfies a second temperature condition by being, for example, below a minimum threshold temperature (e.g., “No” at block 510), the power distribution system 300 can be operated in a pre-heating configuration at block 516. As shown in FIG. 8, the method 500 can reach block 516 prior to charging operations at block 512, but subsequent to charge initialization at block 504, or can reach block 516 after charging operations at block 512 (e.g., in response to battery temperature no longer meeting the first temperature condition noted above). The pre-heating configuration can be substantially similar to the pre-charge configuration, as previously described and as illustrated in FIG. 9. In particular, the pre-charge relay 346 can be in the closed state to equalize voltage across the (open) PDU contactor 374 and the power distribution system 300 can command the charger 354 to supply an electrical current of zero amps, which may cause the charge contactor 358 to be in the open state.

Following pre-heating operations at block 516, the power distribution system 300 can be operated in a heating configuration at block 520. In the heating configuration, electrical current can be supplied to the battery heating circuit 362, which can be an active state, to supply heat to the battery 32 and thus raise the temperature of the battery 320. The particular amperage of the electrical current for the battery heating circuit 362 can be supplied in accordance with a demand of the battery heating circuit 362 or to produce a desired heat output from the battery heating circuit 362, including as controlled by a general control system of a power machine (e.g., via the electronic control device 361). Heat can be supplied to the battery 320 until the battery temperature is at or above the minimum threshold temperature (i.e., “Yes” at block 510), or another temperature level (e.g., a third temperature condition). Once the battery 320 satisfies an appropriate temperature condition (e.g., reaches or exceeds the minimum threshold temperature as noted above), the power distribution system 300 can transition to begin charging the battery 320 at block 508 (i.e., as needed, dependent on a SOC of the battery 320).

In some embodiments, a heating configuration in accordance with block 516 can be a self-heating configuration, in which the battery 320 is discharged to provide electrical current to the battery heating circuit 362. Discharging the battery 320 in the self-heating configuration can also result in ancillary self-heating of the battery 320 (e.g., due to resistive heating from the discharge), as can further contribute to raising the battery temperature.

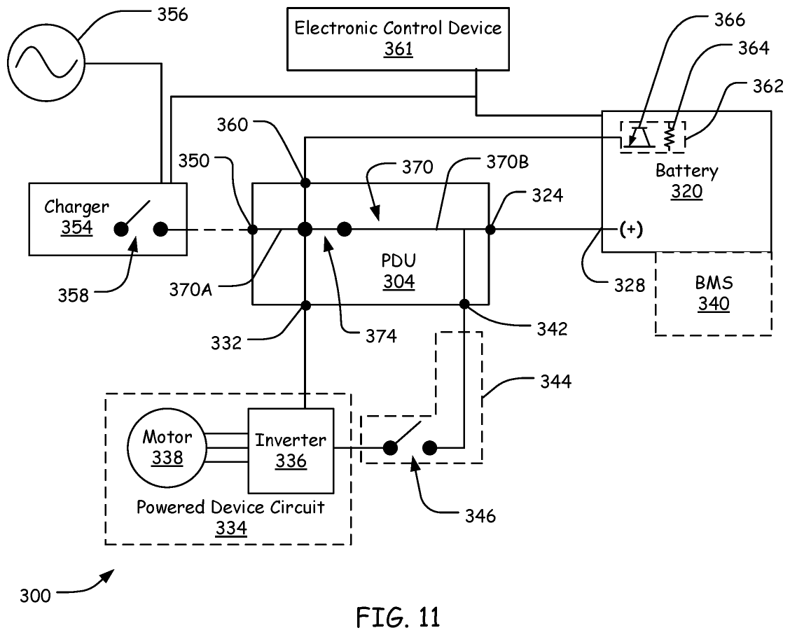

FIG. 11 illustrates the power distribution system 300 in an example self-heating configuration. In the illustrated self-heating configuration, the PDU contactor 374 can be switched to the closed state to electrically couple the battery terminal 328 to the battery heating circuit 362 (e.g., after pre-charge operations as discussed above, and with the pre-charge relay 346 open). Accordingly, electrical current can flow through the bus bar 370 from the battery 320 to the battery heating circuit 362, discharging the battery 320 to heat the battery 320 at the battery heating circuit 362. During heating operations at block 516, in a self-heating configuration, the charger 354 may not supply an electrical current to the PDU 304 (e.g., the charge contactor 358 may be in the open state) and the powered device circuit 334 can be in the inactive state so as not to draw power from the battery 320 across the closed PDU contactor 374.

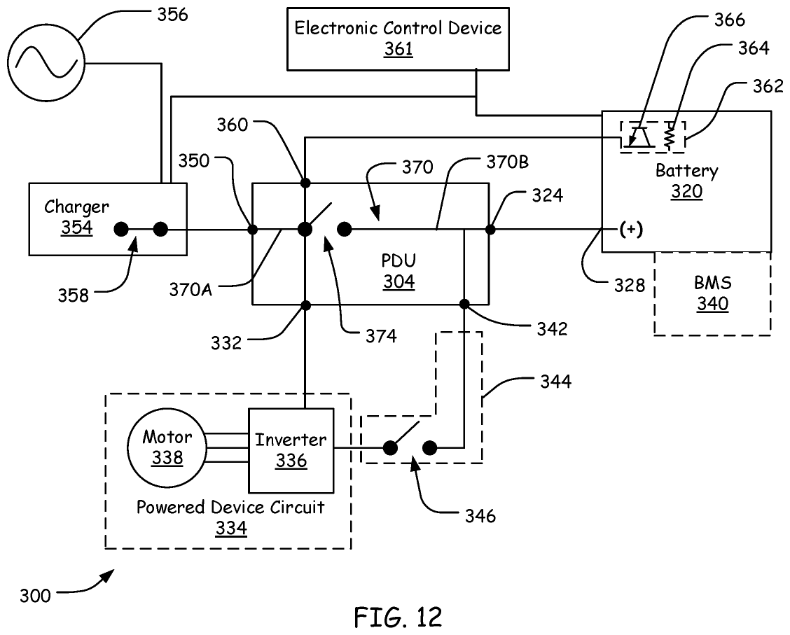

In some embodiments, a heating configuration in accordance with block 516 can be an auxiliary-heating configuration, in which electrical current is provided to the battery heating circuit 362 by an external power source (e.g., the charger 354). For example, FIG. 12 illustrates the PDU 304 in an auxiliary heating configuration (e.g., after pre-charge operations as discussed herein). In particular, the PDU contactor 374 and the pre-charge relay 346 are both open, to prevent electrical current from passing to and from the battery 320 via the bus bar 370, and the powered device circuit 334 can be in the inactive state so as not to operate under power from the charger 354. Correspondingly, the charger 354 can provide an electrical current (i.e., an electrical current with a non-zero amperage) to the battery heating circuit 362 to heat the battery 320, with the battery heating circuit 362 in the active state, and the battery 320 may neither be charged nor discharge in the auxiliary-heating configuration.

In some embodiments, aspects of the technology disclosed herein, including computerized implementations of methods according to the technology disclosed herein, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the technology disclosed herein can be implemented as a set of instructions, tangibly embodied on a non-transitory computer-readable media, such that a processor device can implement the instructions based upon reading the instructions from the computer-readable media. Some embodiments of the technology disclosed herein can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some embodiments, a control device can include a centralized hub controller that receives, processes and (re)transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the technology disclosed herein, or of systems executing those methods, may be represented schematically in the FIGS., or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the technology disclosed herein. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” “device,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some implementations, devices or systems disclosed herein can be utilized, manufactured, installed, etc. using methods embodying aspects of the technology disclosed herein. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the technology disclosed herein, of the utilized features and implemented capabilities of such device or system.

Although the present technology disclosed herein has been described with reference to preferred embodiments, workers skilled in the art will recognize that changes may be made in form and detail to the disclosed embodiments without departing from the spirit and scope of the concepts discussed herein.

What is claimed is:

1. A power distribution system for a power machine that includes a battery, an inverter, and a motor arranged to be powered by the battery through the inverter, the power distribution system comprising:
a power distribution unit (PDU) that includes:
a battery power terminal configured to electrically couple the PDU to a terminal of the battery of the power machine;
a battery heater terminal configured to electrically couple the PDU to a heating circuit for the battery;
a charge terminal configured to electrically couple the PDU to a power supply to charge the battery;
a device power terminal configured to electrically couple the PDU to the inverter of the power machine to power the motor;
a pre-charge terminal configured to electrically couple the PDU to the inverter separately from the device power terminal;
an electrically conductive interconnection that electrically couples the battery power terminal, the battery heater terminal, the charge terminal, the device power terminal, and the pre-charge terminal, wherein the device power terminal, the pre-charge terminal, and the battery heater terminal are electrically connected to the electrically conductive interconnection between the battery power terminal and the charge terminal; and
a PDU switch switchable between an open state and a closed state to control a flow of electrical current through the electrically conductive interconnection; and
wherein, when the PDU switch is in the open state, the pre-charge terminal and the battery power terminal are electrically isolated from the charge terminal, the battery heater terminal, and the device power terminal and, when the PDU switch is in the closed state, the pre-charge terminal and the battery power terminal are electrically connected to the charge terminal, the battery heater terminal, and the device power terminal.

2. The power distribution system of claim 1, wherein the PDU does not include a switch for electrical current flow along the electrically conductive interconnection, other than the PDU switch.

3. The power distribution system of claim 1, wherein the pre-charge terminal is electrically coupled to the electrically conductive interconnection between the PDU switch and the battery power terminal.

4. The power distribution system of claim 1, further comprising:
a pre-charge circuit electrically coupled to the pre-charge terminal and including a pre-charge relay switchable between an open state and a closed state to electrically connect the charge terminal to the battery power terminal through the inverter.

5. The power distribution system of claim 1, wherein the battery heater terminal is electrically coupled to the electrically conductive interconnection so that the PDU switch is positioned between the battery heater terminal and the battery power terminal along the electrically conductive interconnection.

6. The power distribution system of claim 1, further comprising:
a heating circuit electrically coupled to the battery heater terminal and switchable between an active state, in which heat is supplied to the battery by the heating circuit using electrical current from the PDU, and an inactive state, in which heat is not supplied to the battery by the heating circuit.

7. The power distribution system of claim 1, wherein the PDU is configured to switch the PDU switch between the open state and the closed state based on a battery temperature so that:
when the battery temperature is below a threshold temperature, the PDU operates in a heating configuration to supply electrical current to the battery heater terminal; and
when the battery temperature is at or above the threshold temperature, the PDU operates in a charging configuration to supply electrical current from the charge terminal to the battery power terminal.

8. The power distribution system of claim 7, wherein the heating configuration includes at least one of:
a self-heating configuration, wherein the PDU switch is in the closed state so that electrical current flows from the battery power terminal to the battery heater terminal via the electrically conductive interconnection and the PDU switch; or
an auxiliary-heating configuration, wherein the PDU switch is in the open state so that electrical current flows from the charge terminal to the battery heater terminal via the electrically conductive interconnection.

9. The power distribution system of claim 7, wherein, in the charging configuration, the PDU switch is in the closed state.

10. The power distribution system of claim 1, wherein the power distribution unit is disposed within the battery.

11. A power distribution system for a power machine that includes a battery and a load, the power distribution system comprising:
a power distribution unit (PDU) that includes:
a battery power terminal that electrically couples the PDU to a positive terminal of the battery of the power machine;
a battery heater terminal that electrically couples the PDU to a heating circuit for the battery; and
a charge terminal that electrically couples the PDU to a power supply to charge the battery;
an electrically conductive interconnection that electrically couples the battery power terminal, the battery heater terminal, and the charge terminal, wherein the battery heater terminal is electrically connected to the electrically conductive interconnection between the battery power terminal and the charge terminal; and
a PDU contactor switchable between an open state and a closed state to control a flow of electrical current through the electrically conductive interconnection, wherein:
in the open state, the PDU contactor electrically isolates the battery power terminal from the charge terminal and the battery heater terminal; and
in the closed state, the PDU contactor electrically connects the battery power terminal to the charge terminal and the battery heater terminal.

12. The power distribution system of claim 11, wherein the PDU does not include an additional contactor for the electrically conductive interconnection.

13. The power distribution system of claim 11, wherein the PDU further includes a first load terminal configured to electrically couple the PDU to the load;
wherein the first load terminal is electrically connected to the electrically conductive interconnection between the charge terminal and the battery power terminal; and
wherein:
in the open state, the PDU contactor electrically isolates the battery power terminal from the first load terminal; and
in the closed state, the PDU contactor electrically connects the battery power terminal to the first load terminal.

14. The power distribution system of claim 13, wherein the PDU further includes a second load terminal configured to electrically couple the PDU to the load separately from the first load terminal;
wherein the second load terminal is electrically connected to the electrically conductive interconnection between the charge terminal and the battery power terminal; and
wherein:
in the open state, the PDU contactor electrically isolates the second load terminal from the first load terminal; and
in the closed state, the PDU contactor electrically connects the second load terminal to the first load terminal.

15. A method of operating a battery for a power machine, the method comprising:
when a battery temperature is below a threshold temperature, heating the battery by supplying an electrical current to a heating circuit using a power distribution system, the heating circuit being in an active state to supply heat to the battery, the power distribution system including an electrically conductive interconnection with a first contactor that is switchable between an open state and a closed state to control a flow of electrical current through the electrically conductive interconnection, the electrically conductive interconnection being electrically coupled to a positive terminal of the battery, the heating circuit, and a charger for the battery so that the first contactor is between the heating circuit and the positive terminal of the battery and between the charger and the positive terminal of the battery; and
when the battery temperature is at or above the threshold temperature, charging the battery by supplying electrical current from the charger to the battery with the first contactor in a closed state and with the heating circuit in an inactive state, in which heat is not supplied to the battery by the heating circuit.

16. The method of claim 15, further comprising:
while supplying the electrical current to heat the battery, operating the power distribution system in a self-heating configuration, wherein the first contactor is in a closed state so that electrical current flows from the battery to the heating circuit via the first contactor.

17. The method of claim 15, further comprising:
while supplying the electrical current to heat the battery, operating the power distribution system in an auxiliary-heating configuration, wherein the first contactor is in an open state and electrical current flows from the charger to the heating circuit via the electrically conductive interconnection.

18. The method of claim 15, further comprising:
closing a pre-charge relay of a pre-charge circuit prior to charging the battery, to provide an electrical current to a powered device circuit to charge capacitive elements in the powered device circuit.

19. The method of claim 15, further comprising:
discharging the battery to an electrical load for operation of the power machine, including:
with the first contactor in the open state, temporarily switching a second contactor to a closed state to electrically connect the charger to the positive terminal of the battery through a load;
after temporarily switching the second contactor to the closed state, switching the first contactor to a closed state to electrically couple the positive terminal of the battery to the load; and
after switching the first contactor to the closed state, switching the second contactor to the open state to power the load with the battery through the first contactor.

20. The method of claim 15, further comprising:
detecting, with an electronic controller, that the charger electrically connects a power supply to the power distribution system; and
in response to detecting that the power supply is electrically connected to the power distribution system by the charger, operating, with the electronic controller, the heating circuit in an active state, to heat the battery using electrical current from the charger.
